(19) United States
(12) Patent Application Publication
(10) Pub. No.: US 2008/0252661 A1
(43) Pub. Date: Oct. 16, 2008

(54) Interface for Computer Controllers

(76) Inventor: John Allen Hilton, New South Wales (AU)

Correspondence Address: OSTROLENK FABER GERB & SOFFEN, 1180 AVENUE OF THE AMERICAS, NEW YORK, NY, 100368403, US

(21) Appl. No.: 12/088,123

(22) PCT Filed: Sep. 27, 2006
(86) PCT No.: PCT/AU2006/001412

§ 371 Date: Mar. 26, 2008

(30) Foreign Application Priority Data
Sep. 27, 2005 (AU) 2005905303

(51) Int. Cl. G09G 5/00

(52) U.S. Cl. 345/649

(57) ABSTRACT

A software module for providing a user interface for a hardware peripheral device for controlling graphical elements of a virtual world defined in a computer system and rendered on a display device of the computer system, the module providing software including motion algorithms, and the module being capable of generating, with reference to the rendered graphical element, an icon (hereinafter called a motion handle) which represents a point in three dimensional space about which the graphical element may be manipulated, the point being used by the algorithms as the centre of rotation and zoom, and being used to define relative panning speeds whereby the algorithms cause changes to the rendered image of the graphical element responsive to rotation, zoom and pan input signals generated in the peripheral device.

### FIELD OF THE INVENTION

The present invention relates to a system and method for use with a computing system to control motion of three-dimensional (3D) objects and views.

### BACKGROUND OF THE INVENTION

A Graphical User Interface (GUI) is an interface between a user and a computer which utilizes a computer's two-dimensional (2D) graphics capabilities to make it easier for a non-expert to use a complex program. A more traditional type of user/computer interface is a Command Driven Interface that responds to commands typically typed in by the user.

The vast majority of computer usage today occurs through interaction with a GUI. Features of common GUIs include; a cursor or pointer, a pointing device, icons, a desktop, windows and menus. More recently computers have become powerful enough for interactive 3D applications. Common 3D applications are games, computer aided design and animation.

Interactive 3D or spatial control involves the use of input devices, menus and other GUI components to control the displayed image of a 3D scene. The term ‘Spatial User Interface’ (SUI) is introduced here to identify the interaction techniques and GUI components that provide interactive spatial control. Notable spatial interactions are pan, zoom and spin.

Viewing is the projection or mapping of a 3D scene (represented in the virtual world by a set of data defining all relevant physical characteristics of the scene) onto a 2D screen. This may be described as mapping a virtual world view “volume” to a display device screen “volume”. The “virtual world view volume” is a region of the virtual world that is rendered (and given physical appearance) in the display device. Thus a view is a particular selection.

Viewing implementations vary significantly across 3D applications even though the fundamental viewing principles are the same. Interactive spatial control uses and modifies viewing parameters. Although applications have similar spatial control requirements they tend to use different SUIs. Users end up learning different ways of performing essentially the same operations. Advanced features, such as stereo viewing, are rarely implemented and are considered difficult even though these features are a small extension to well architected viewing code. Also, the wide variety of viewing parameters and lack of a spatial control interface significantly hinders the introduction of new types of input devices.

Existing SUIs are awkward to use and only users who derive real benefits from 3D applications put in the effort to learn how to use them. The average computer user hardly, if ever, uses interactive spatial control. A SUI that maps physical input device characteristics to output display responses provides a far more useable interface for both the experienced and the average user.

### SUMMARY OF THE INVENTION

Broadly, the present invention concerns a software module for providing a user interface for a hardware peripheral device for controlling graphical elements of a virtual world defined in a computer system and rendered on a display device of the computer system, the module providing software including motion algorithms, and the software being capable of generating, with reference to the rendered graphical element, an icon (hereinafter called a motion handle) which represents a point in three dimensional space about which the graphic element may be manipulated, the point being used by the algorithms as the centre of rotation and zoom, and being used to define relative panning speeds whereby the algorithms cause changes to the rendered image of the graphical element responsive to rotation, zoom and pan input signals generated in the peripheral device.

More particularly, embodiments may have means to permit a software module as claimed in claim 1, and further comprising means to permit a user to operate the module for graphical element viewing in either orthographic or perspective mode.

Embodiments use a spatial user interface for a computing system, comprising a software application arranged to interface with a hardware device to control virtual 3D objects and views thereof rendered on a display device, the software application including a viewing module and associated motion algorithms that take into account viewing parameters so as to mimic the physical characteristics of the hardware device to manipulate one or more objects or views on display device.

Embodiments may further include algorithms which a software module as claimed in claim 1, wherein the algorithms include algorithms which, on manipulation of the peripheral device produce consistent pan, zoom and spin responses of the graphical item being controlled in relation to the rendered image where the responses are independent of the type, position, orientation or scale of the view and where, in the case of a perspective view the pan response of the motion handle is consistent, whereby there is mimicking of the physical characteristics of the peripheral device.

Alternatively, the present invention may be expressed as a software package for managing signals from a peripheral input device in a computer system, the package including a set of velocity control motion algorithms that, respond to:
(a) a 2D pan velocity input in terms of viewport or screen dimension per second,
(b) a zoom velocity in terms of scale rate, and
(c) a spin velocity, in terms of rotation rate, and produce display motion corresponding to the specified input values for all types of perspective or orthographic views with any position, orientation or scale, the velocity control motion algorithms include one set of motion algorithms based on a 3D point used for specifying the panning response, the zoom centre and the spin centre, and a second set of motion algorithms for perspective views having a plane, parallel to the eye space X-Y plane for specifying the panning response, the zoom centre being the centre of the viewport and the spin centre being the perspective eyepoint.

In another aspect, an inventive approach now disclosed may be defined as a viewing toolkit comprising data definitions and software for use with a 3D graphics application programmers' interface (API) adapted to render geometric items and having means to configure transformations and other parameters which determine how the geometric items are rendered, the API being useable with a 3D virtual world having the geometric items and the transformation items defined in a tree-like data structure, and wherein the toolkit is to be used with a system having a screen viewport and a depth buffer range which specifies a screen volume and 3D world space is used as a reference frame for all the 3D graphical items,
the toolkit using eye space defined within the tree structure which defines a view volume which may have a rotate and/or a translate transformation in relation to world space and no other transformations,
the toolkit specifying a generic 2D shape defined in eye space and being located parallel to the X-Y plane of eye space,
a data set of viewing parameters which provide at any time any one of a right or skewed prismatic volume, or a right or skewed frustum volume defined in eye space whereby a generic view volume is defined by either sweeping the generic 2D shape along a line segment or by scaling the generic 2D shape between two positive values about an eye space eye point, the toolkit further defining a viewport specific view volume that just encompasses the generic view volume and has a cross-sectional shape matching the screen viewport shape, and a means for configuring the 3D graphics API to map the viewport specific view volume to the viewport's screen volume.

Yet a further aspect consists in a 3D motion toolkit for use with a viewing toolkit, the motion toolkit providing both positional and velocity interaction motion algorithms having calculations that deliver consistent screen based motion for a given input value or values irrespective of the type, position, orientation or size of the view, one set of motion algorithms being based on a 3D point defining a pan response and a centre of zoom and rotation and another set of the motion algorithms define and use a characterising plane parallel to the eye space X-Y plane whereby the panning rate of graphical items in the characterising plane matches the panning and instantaneous zooming of graphical items in the characterising plane match the panning and instantaneous zooming rates of the 3D point of the first set of motion algorithms when the 3D point lies in the characterising plane.

### DETAILED DESCRIPTION OF THE DRAWINGS

Features of the present invention will be presented in a description of an embodiment thereof, by way of example, with reference to the accompanying drawings, in which:

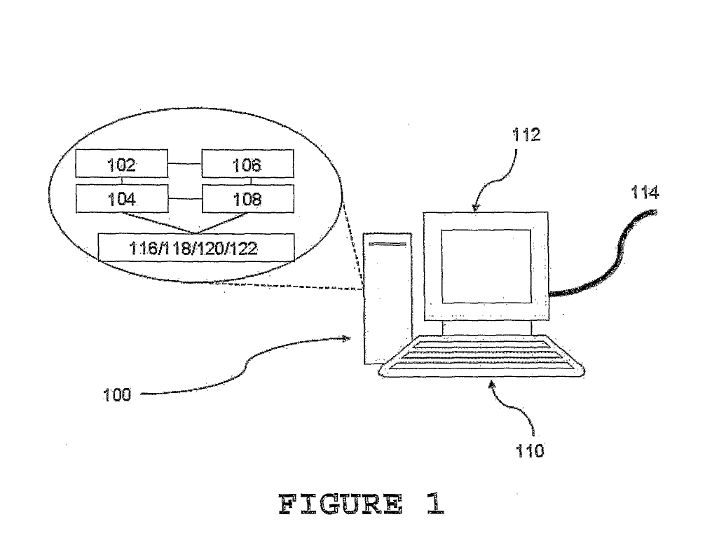

FIG. 1 is a computing system suitable for implementing an embodiment of the present invention;

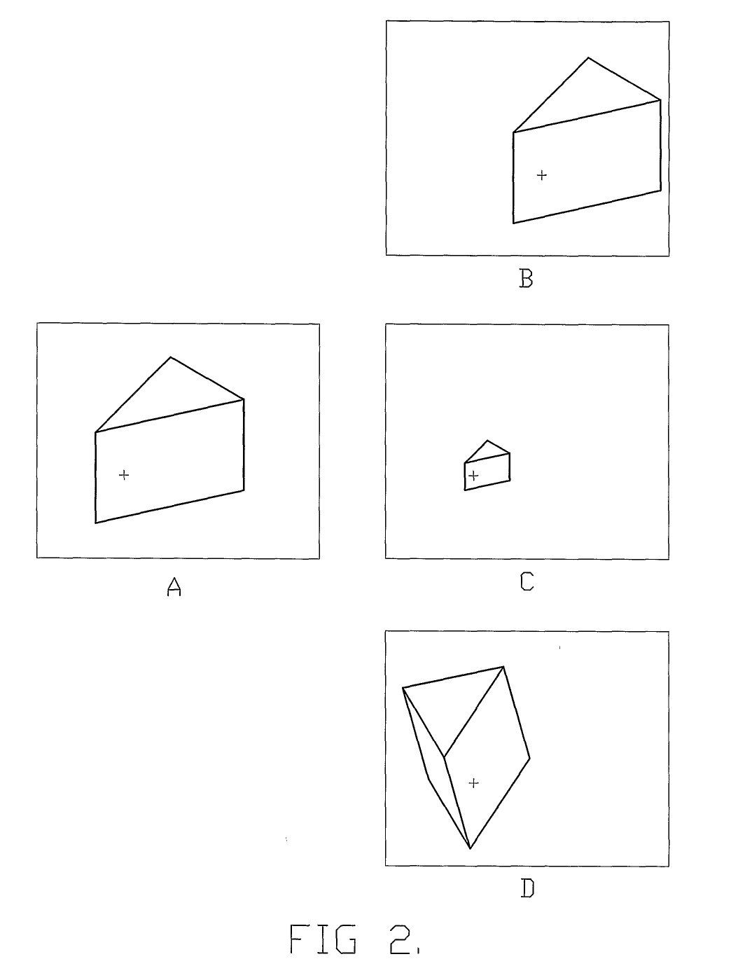

FIG. 2 is an illustration of pure panning, zooming and spinning of a graphical item as implemented by an embodiment of the present invention;

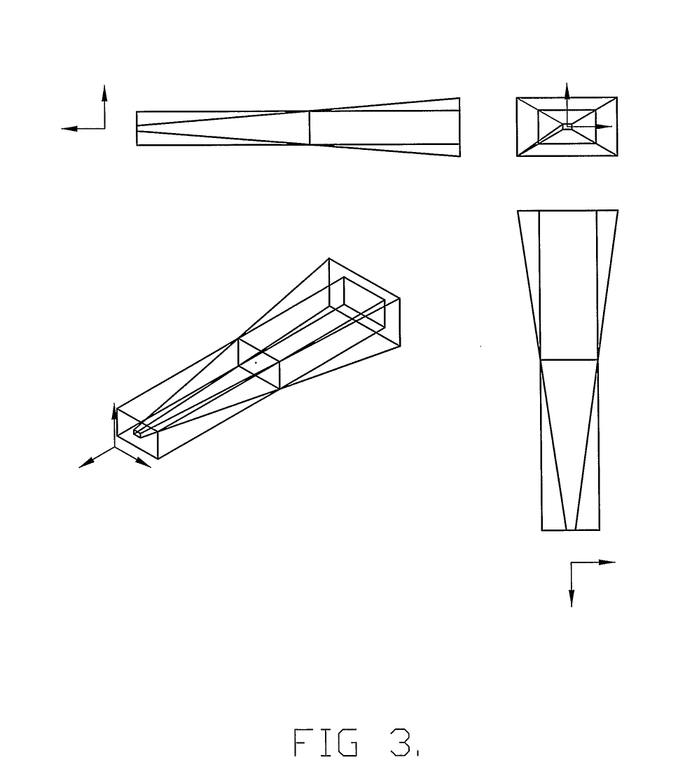

FIG. 3 is an illustration of right orthographic and perspective view volumes as may be utilised in embodiments, and

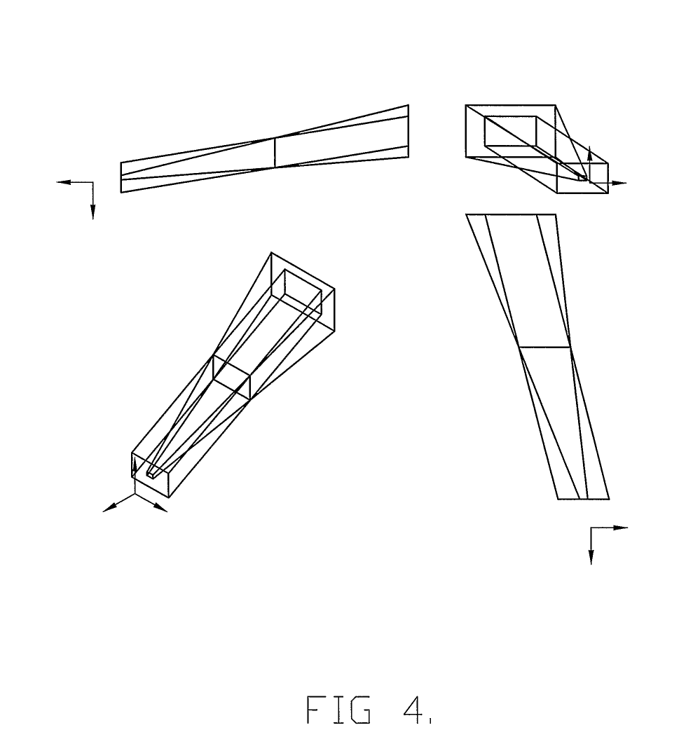

FIG. 4 is an illustration of skewed orthographic and perspective view volumes as may be utilised in embodiments.

General Architecture for a Specific Embodiment

At FIG. 1 there is shown a schematic diagram of a computing system 100 suitable for use with an embodiment of the present invention. The computing system 100 may be used to execute applications and/or system services such as a Spatial User Interface (S.U.I) in accordance with an embodiment of the present invention. The computing system 100 comprises a processor 102, read only memory (ROM) 104, random access memory (RAM) 106, and input/output devices such as disk drives 108, input peripherals such as a keyboard 110 and a display (or other output device) 112. The computer includes software applications that may be stored in RAM 106, ROM 104, or disk drives 108 and may be executed by the processor 102.

A communications link 114 connects to a computer network such as the Internet. However, the communications link 114 could be connected to a telephone line, an antenna, a gateway or any other type of communications link. Disk drives 108 may include any suitable storage media, such as, for example, floppy disk drives, hard disk drives, CD ROM drives or magnetic tape drives. The computing system 100 may use a single disk drive 108 or multiple disk drives. The computing system 100 may use any suitable operating systems 116, such as Microsoft Windows™ or a Unix™ based operating system.

The system further includes software modules 118. The software modules 118 may interface with an application 120 (in accordance with an embodiment of the present invention) in order to provide a spatial user interface, and may interface with other software applications 122.

Background Concepts and Definitions

Rendering is the process of generating a display image from virtual world data. Rendering involves viewing which is a process of mapping a virtual world view volume to a region on the screen called a viewport. A concept of screen depth is used for the purpose of hiding graphical items that are behind other graphical items. A common hiding technique uses a Z-buffer that is well understood in the art. A screen volume is then defined here as the viewport plus depth range. Viewing can then be said to map a virtual world view volume to a screen volume.

A virtual world consists of displayable graphical items and data that affects how these items are rendered, such as transformations and lighting. Graphical items include points, lines, surfaces, groups of surfaces forming complete objects, assemblies of objects, cameras, lights, fog and other items that affect a rendered image. The complete virtual world itself can be considered a graphical item. Notably a camera is used in specifying a view.

The noun ‘space’ is used to denote a particular coordinate system. There are two possible arrangements of the X, Y, and Z axes that are termed left and right handed coordinate systems in the art. Transformations, such as translation, rotation and scale, map one space to another.

A study of computer graphics includes the notion of a display tree that provides a number of features such as grouping graphical items into assemblies and having transformations affect subsequent items in the associated branch. Each transformation relates one space to another. The top level space of the display tree is termed simply ‘world space’. In many 3D applications, the display tree is shown as a tree-like structure similar to that often seen when viewing directories of computer files.

A virtual world can be as simple as a single object and a single camera used to view that object with a single transformation relating the object to the camera. In object control (defined below) the camera is considered fixed in world space and the object moved accordingly. In camera control (defined below) the object is considered fixed in world space and the camera moved accordingly.

The term ‘frame’ is derived from the movie industry and indicates one rendering operation. The frame rate is commonly specified as frames per second being the number of complete virtual world rendering operations per second.

There are two common types of projections in computer graphics, namely orthographic and perspective. Other projections are possible, such as fish-eye projections, but these are rare in computer graphics. As will be appreciated from the disclosure below, embodiments of the invention include application to orthographic and perspective projections but embodiments also extend to other projections.

An orthographic view projects graphical items onto a virtual display surface using parallel projection rays. An orthographic view volume can be described as sweeping a flat virtual world 2D shape matching the viewport's shape along a straight line segment. The line segment is often at right angles to the flat shape but need not be. The right and skewed orthographic view volumes are respectively illustrated in FIGS. 3 and 4 as are the right and skewed perspective view volumes.

A perspective view projects images onto a virtual display surface using rays passing through a point called an eyepoint. A perspective view volume can be described by linearly scaling a flat shape matching the viewport's shape from one scale value to another about the eyepoint. Often the line from the centre of the flat shape to the eyepoint is normal to the flat shape's plane but it need not be.

As will be clear from the following descriptions, the embodiments of the present invention related to interface for various input devices. An especially valuable input device is a spatial controller that simultaneously detects a 3D force and a 3D torque applied by the user's hand to some type of grip. One example is the present inventor's controller described in PCT Application entitled “Three-Dimensional Force and Torque Converter”, publication Number WO 2004/037497 A1.

Overview of an Embodiment of the Invention

A main aspect of embodiments of the invention is to match the physical characteristics of an input device or devices to the virtual world motions being controlled. Considering the system as a classic black box, the measurable inputs are, for instance, the physical position, orientation, velocity, force and/or torque provided by the input device (such as the spatial controller mentioned above) and the main measurable outputs are the pan, zoom and spin responses.

Embodiments of the present invention can use relevant transformations and algorithms commonly used when dealing with the display tree so as to implement particular interaction techniques embodying the present invention. In particular, the spatial correlation between the physical device and the virtual world must be handled by motion algorithms by transforming motion vectors appropriately into required display tree spaces.

FIG. 2 illustrates a screen display of an arbitrary object with a “motion handle” in accordance with the novel approach defined herein applied as an icon to the image. View A shows an arbitrary view of the object and Figures B, C and D respectively show the effect of pure panning, pure zooming and pure spinning. It will seem that the motion handle (icon) remains on the same 3D spot on the object as a reference point.

Embodiments of the invention need to recognise that, as discussed above, there are two main types of view, namely orthographic and perspective.

Furthermore, there are two main types of interaction, namely positional and velocity. There are two main spatial control modes, namely object and camera.

Positional/Velocity Interaction

Positional interaction typically uses input data to control a graphical item's pan position, zoom size and/or spin orientation or to control the virtual camera's position, orientation and orthographic view size or perspective view angle.

Various input devices, such as mice, digitizing tablets, trackballs and joysticks, can be used to control the position of a cursor on the screen. The cursor's position is considered, for the purposes of interaction, to be the input devices' physical position and is used, in turn, to control motion often with respect to either the centre of the screen or the point at which a mouse button was pressed. From a programming perspective the input data used by a motion algorithm is a current cursor position and, when needed, a reference cursor position. In some cases, the reference position is set when an event, such as depressing a mouse button, occurs and sometimes the reference position is updated to the current cursor position after an iteration of the motion algorithm. Updating the reference position essentially provides a delta movement that is used by the motion algorithm.

Velocity interaction typically uses input data to control a graphical item's pan, zoom and spin speed or to control the ritual camera's speed of movement or spin. The rate of change of an orthographic view's size or a perspective view's angle can also be controlled. Data from spatial controllers is almost always used for velocity interaction. Velocity data can be generated from a number of sources such as cursor movement, joysticks or button presses. To effectively use velocity interaction requires integration over time to produce delta motion. Integration is simply implemented by scaling by the frame period. In certain situations the frame period is not consistent and can jump around in which case a predictive algorithm or an averaging algorithm is used to produce acceptable results.

ObjectiCamera Control

There are two main modes of spatial interaction namely Object Control and Camera Control. Object Control operates by moving a graphical item around in the virtual world. Camera Control operates by moving the virtual camera around in the virtual world and is only valid for perspective views.

The Object Control set of motion algorithms produce motion responses in relation to the motion handle. Panning of and zooming and spinning about the motion handle is consistent for a given set of input values independent of the view's type, size, position or orientation or of the placement of the motion handle or the graphical item being controlled in the virtual world-tree like data structure.

The Camera Control set of motion algorithms are only valid for perspective views. A pan/zoom reference plane parallel to the eye space X-Y plane at a specified distance from the eyepoint is defined. The motion algorithms produce consistent instantaneous panning and zooming responses of graphical items in the pan/zoom reference plane. The spin centre is the eyepoint and zoom centre is the centre of the viewport.

Interaction occurs in relation to a view. In the case of multiple views one of the views needs to be selected as the active view. Similarly interaction typically operates on a single graphical item and so one of the items needs to be selected as the active item.

Preferably the contents of the virtual world are displayed in a companion window in a tree-like structure. The list of graphical items should include the top level world as well as a virtual camera for each view. Object Control is used for moving graphical items unless a camera is selected and its corresponding view is active in which case Camera Control is used.

In embodiments of the invention, the motion handle is optionally displayed as a small 2D overlay graphic figure, similar in nature to a cursor, drawn over the position of the 3D point of the motion handle in the virtual world.

The motion handle can be repositioned using various common techniques for positioning points in world space. In a preferred embodiment, the motion handle is placed by using the cursor to pick a point on a visible surface. It is generally associated as a fixed position relative to a graphical item.

In the case of cursor controllers, various algorithms may be used to move the cursor but the cursor position is considered the input value for interaction purposes from these devices.

Spatial controllers preferably provide output responses velocities that are a cubic function of the input force and torque values for providing fine control with light pushes and twists and fast control with stronger pushes and twists. Notably the orientation of the input device should match the orientation of the resulting screen motion.

When toggling a view between an orthographic and perspective view type, the distance of the Object Control motion handle and the Camera Control pan/zoom reference plane distance provide a convenient toggling plane distance whereby graphical items lying in the toggling plane appear identical in both the orthographic view and the perspective view.

The techniques so far described have related to a single view, a single viewport, a single motion handle and a single input device of any particular type. In an embodiment there can be any number and combination of views, viewports, motion handles, input devices, etc.

Implementation of embodiments may be via two software modules or toolkits, especially when a spatial controller and a conventional mouse are used as peripheral devices. A first toolkit is used to apply motion algorithms to signals from drivers associated with a peripheral device to provide the described responses and the second toolkit relates to preferred mapping of the virtual view volume to screen volume and in doing so providing a set of viewing parameters useful for motion algorithms. In addition, this toolkit can set the virtual view volume to match the physical user viewing geometry.

This second toolkit will be further explained and be better understood by recognising that a number of spaces are used in the definitions of the various items. There are three main reference spaces; virtual world space, screen space and real world space. Virtual world space is used for virtual world items, screen space is used for pixel/Z-buffer items and real world space is used for physical items. Virtual world space is abbreviated here to just ‘world space’.

A screen volume is defined as the viewport's centre, width and height and a Z-buffer depth range in screen space or, where dictated by the underlying operating system, a client space. Client space is the client window common in the art and a ClientToScreen 2D pixel translation maps it to screen space.

A view volume, left and right stereo eyepoints and a limiting front clipping plane value are defined in eye space. An EyeToWorld transformation maps eye space to world space. Eye space corresponds to a virtual camera's CameraToWorld transformation but only uses the rotate/translate transformations. A camera can be located at any point in a display tree although cameras are usually immediate children of world space.

A screen is defined by its pixel dimensions in screen space and the corresponding physical dimensions, position and orientation in real world space are used to form a ScreenToRealWorld transformation. The second toolkit automatically handles non-square pixels that often occur with stereo viewing display modes.

A real user's left and right eyes are defined in the real user's head space which is mapped to user space by a RealHeadToRealWorld transformation.

The view volume is derived from an eye space square defined to lie parallel to the eye space X-Y plane. An eye space 3D point specifies the square's centre. A negative Z-axis coordinate specifies a right handed eye space and a positive value a left handed one. The length of the square's edge completes the eye space square definition.

A display rectangle is defined containing the eye space square and matching the shape of the screen's viewport. Front and back clipping planes are defined parallel to the eye space X-Y plane and are defined with eye space Z-axis coordinates. An orthographic view volume is defined by sweeping the display rectangle translationally along the axis defined by the eyepoint and viewpoint and between the clipping planes. A perspective view is defined volume by scaling the display rectangle about the eyepoint between the clipping planes. FIGS. 3 and 4 illustrate right and skewed perspective and orthographic view volumes.

Listing the parameters specifying a view:

Screen Volume:
Viewport's 2D centre position;
Viewport width and height;
Z-buffer front and back values.
ClientToScreen 2D pixel translation (where required)

View Volume (Also Requires Viewport Width and Height):
Projection type (orthographic or perspective)
Square centre point;
Square size;
Front and back clipping plane Z-axis coordinates.
EyeToWorld translate/rotate transformation;

This information fully specifies all possible orthographic and perspective viewing transformations for rendering a view volume to a screen volume.

When a viewport is partially obscured by another window or windows it is possible to optimize the transformation pipeline to render only the visible portions contained within an encompassing rectangle.

The first toolkit can work with the second toolkit and can supply of interactive motion algorithms enabling the targeted input/output responses. Object and camera control algorithms for velocity interaction are used and explained below to present the techniques needed to implement the interactions specified earlier. Positional algorithms employ similar techniques.

The velocity interaction algorithms have velocity inputs defined to allow any number of input devices to be used.

Velocity/Camera Control Motion Algorithm

Camera control modifies a CameraToParent transformation to implement the motion. The algorithm is generalized using a parent space where the ParentToWorld transformation is the combination of any and all transfonnations occurring between the world and the camera's parent space.

Given a
period
2D pan velocity
zoom velocity
3D spin velocity
CameraToParent transformation
ParentToWorld transformation
Pan/zoom reference plane distance

Form a 3D pan/zoom vector and transform this and the spin velocity vector from eye space to parent space using the rotate and translate transformations of the CameraToWorld transformation and scaling the translational velocity by the inverse of the ParentToWorld scale transformation. Convert these velocity vectors to translational and rotational displacement vectors by multiplying by the period. Scale the x and y delta translational values by the tangent of half the widest of the horizontal or vertical view angles and also multiply by pan/zoom reference plane distance. Add the resulting delta translation transformation to the CameraToParent translation transformation. Calculate a camera space delta rotation transform using the length of the delta rotation vector as the angle with an axis defined by the delta rotation vector. Combine the camera space delta rotation transformation with the current CameraToWorld rotation transformation to produce the new CameraToWorld rotation transformation.

Velocity/Object Control Motion Algorithm

Object control updates the ObjectToParent transformation and the view size, for zoom of orthographic views, to implement the specified motion. The algorithm is generalized in a similar way to Camera Control by defining a ParentToWorld transformation. The motion handle can exist anywhere in the display tree but needs to be transformed to object space for use by the algorithm.

Given a
period
2D pan velocity
zoom velocity
3D spin velocity
ObjectToParent transformation
ParentToWorld transformation
EyeToWorld transformation
Motion Handle point in object space
View Volume
bend-translation-vector and a bend-rotation-vector flags

Transform the motion handle to eye space by transforming by the ObjectToParent and ParentToWorld transformations then transforming by the inverse of the EyeToWorld transformation.

Use the 3D rotational velocity vector to define an eye space delta rotation vector. For perspective views optionally bend the delta rotation z value, based on the bend-rotation-vector flag and possibly on other conditions such as whether the motion handle is within the view volume, bend the eye space z delta rotation vector by adding to each of the x and y delta rotation values a value being the delta rotation z value multiplied by the corresponding x or y eye space motion handle value divided by the eye space motion handle z value. This has the effect of being the delta z direction to point to/from the eye space origin. Transform the resulting delta rotation vector from eye space to parent space using only the rotation transformations of the EyeToWorld and ParentToWorld transformations. Calculate a delta rotation transformation where the angle is the length of the delta rotation vector multiplied by the period and the axis is defined by the delta rotation vector. Apply the parent space delta rotation to the ObjectToParent transformation so the rotation occurs about the motion handle.

For perspective views;

Calculate a velocity-to-displacement panning factor as the tangent of half the widest of the horizontal and vertical view angles multiplied by the distance of the eye space motion handle from the X-Y eye space plane. Calculate the eye space 2D delta pan translation transformation as the pan velocity multiplied by the period and the velocity-to-displacement panning factor. Calculate a zoom power value being the period multiplied by the zoom velocity. The zoom power value may need to be negated depending on the implementation. Calculate a zoom factor as two to the power of the power value then subtract 1.0. Calculate a delta Z translation by multiplying the eye space motion handle Z value by the zoom factor. The eye space delta translation can be considered to move the eye space motion handle. Optionally, bend the eye space delta translation vector by adjusting the x and y components in the same way as bending the eye space delta rotation vector. Transform the eye space motion handle to parent space using the EyeToWorld and ParentToWorld transformations appropriately. Add the parent space delta translation to the ObjectToParent translation transformation.

For Orthographic views;

Calculate an eye space delta pan vector by multiplying the pan velocity vector by the period and the length of the longest length of the view volume's width or height. Calculate the delta zoom power as the negative delta zoom velocity multiplied by the period. Calculate a zoom factor as two to the power of the zoom power. Scale the view volume's width and height by the zoom factor. Calculate the 2D motion handle position in the view volume with (0,0) being the middle of the view. Multiply this position by (zoom−1) to calculate an adjusting vector so as to keep the motion handle on the same pixel before and after the zoom is applied. Add this adjusting vector to the eye space delta pan vector. Transform the delta pan vector from eye space to parent space using the EyeToWorld rotation transformation and the ParentToWorld rotation and scale transformations appropriately. Add the parent space delta translation to the ParentToWorld translation transformation.

1. A software module for providing a user interface for a hardware peripheral device for controlling graphical elements of a virtual world defined in a computer system and rendered on a display device of the computer system, the module providing software including motion algorithms, and the module being capable of generating, with reference to the rendered graphical element, an icon (hereinafter called a motion handle) which represents a point in three dimensional space about which the graphical element may be manipulated, the point being used by the algorithms as the centre of rotation and zoom, and being used to define relative panning speeds whereby the algorithms cause changes to the rendered image of the graphical element responsive to rotation, zoom and pan input signals generated in the peripheral device.

2. A software module as claimed in claim 1, and further comprising means to permit a user to operate the module for graphical element viewing in either orthographic or perspective mode.

3. A software module as claimed in claim 1, wherein the algorithms include algorithms which, on manipulation of the peripheral device produce consistent pan, zoom and spin responses of the graphical item being controlled in relation to the rendered image where the responses are independent of the type, position, orientation or scale of the view and where, in the case of a perspective view the pan response of the motion handle is consistent, whereby there is mimicking of the physical characteristics of the peripheral device.

4. A software module as claimed in claim 1, wherein the motion algorithms are based on a cubic function of velocity against force and/or torque applied to the peripheral device.

5. A software module as claimed in claim 1 wherein the software module includes a viewing toolkit comprising data definitions in software for use with a 3D graphics application programmers interface (API) adapted to render geometric items and having means to configure transformations and other parameters which determine how the geometric items are rendered, the API being usable with a 3D virtual world having the geometric items and the transformations items defined in a tree-like data structure, and wherein the toolkit is to be used, with a system having a screen viewport and a depth buffer range which specify a screen volume and 3D world space is used as a reference frame for all the 3D graphic items, the toolkit using eye space, defined within the tree structure, which defines a view volume that may have a rotate and/or a translate transformation in relation to world space and no other transformations, the toolkit specifying a generic 2D shape defined in eye space and being a shape located parallel to the X-Y plane of eye space, a data set of viewing parameters which provide, at any time, any one of a right or skewed prismatic volume or a right or skewed frustum volume defined in eye space whereby a generic view volume is defined by either sweeping the generic 2D shape along a line segment or by scaling the generic 2D shape between two positive values about an eye space eyepoint, the toolkit further defining a viewport specific view volume that just encompasses the generic view volume and has a cross sectional shape matching the screen viewport shape and a means for configuring the 3D graphics API to map the viewport specific view volume to the viewport's screen volume.

6. A software module as claimed in claim 5, wherein the software module has means for supporting non-square pixels in the screen volume.

7. A software module as claimed in claim 5, wherein the software module has means for supporting stereo viewing.

8. A software module as claimed in claim 4, wherein the software module has means for trimming a portion of the view volume where the viewport is obscured by other windows.

9. A viewing software toolkit comprising data definitions and software for use with a 3D graphics application programmers' interface (API) adapted to render geometric items and having means to configure transformations and other parameters which determine how the geometric items are rendered, the API being useable with a 3D virtual world having the geometric items and the transformation items defined in a tree-like data structure, and wherein the toolkit is to be used with a system having a screen viewport and a depth buffer range which specifies a screen volume and 3D world space is used as a reference frame for all the 3D graphical items,
the toolkit using eye space defined within the tree structure which defines a view volume which may have a rotate and/or a translate transformation in relation to world space and no other transformations,
the toolkit specifying a generic 2D shape defined in eye space and being located parallel to the X-Y plane of eye space,
a data set of viewing parameters which provide at any time any one of a right or skewed prismatic volume, or a right or skewed frustum volume defined in eye space whereby a generic view volume is defined by either sweeping the generic 2D shape along a line segment or by scaling the generic 2D shape between two positive values about an eye space eye point,
the toolkit further defining a viewport specific view volume that just encompasses the generic view volume and has a cross-sectional shape matching the screen viewport shape, and a means for configuring the 3D graphics API to map the viewport—specific view volume to the viewport's screen volume.

10. A software toolkit as claimed in claim 9 wherein the screen volume definition provides for support on non-square pixels.

11. The software toolkit as claimed in claim 9 and having means for trimming a portion of the view volume where the viewport is obscured by other windows.

12. A 3D motion toolkit for use with a viewing toolkit, the motion toolkit providing both positional and velocity interaction motion algorithms having calculations that deliver consistent screen based motion for a given input value or values irrespective of the type, position, orientation or size of the view, one set of motion algorithms being based on a 3D point defining a pan response and a centre of zoom and rotation and another set of the motion algorithms define and use a characterising plane parallel to the eye space X-Y plane whereby the panning rate of graphical items in the characterising plane matches the panning and instantaneous zooming of graphical items in the characterising plane match the panning and instantaneous zooming rates of the 3D point of the first set of motion algorithms when the 3D point lies in the characterising plane.

13. A software package for managing signals from a peripheral input device in a computer system, the package including a set of velocity control motion algorithms that, respond to:
(a) a 2D pan velocity input in terms of viewport or screen dimension per second,
(b) a zoom velocity in terms of scale rate, and
(c) a spin velocity, in terms of rotation rate,
and produce display motion corresponding to the specified input values for all types of perspective or orthographic views with any position, orientation or scale, the velocity control motion algorithms include one set of motion algorithms based on a 3D point used for specifying the panning response, the zoom centre and the spin centre, and a second set of motion algorithms for perspective views having a plane, parallel to the eye space X-Y plane for specifying the panning response, the zoom centre being the centre of the viewport and the spin centre being the perspective eyepoint.
